(19) United States
(12) Patent Application Publication
(10) Pub. No.: US 2024/0423180 A1
(43) Pub. Date: Dec. 26, 2024

(54) System and Method for Making a Fishing Bait by Utilizing a Bait Mesh Wrap

(71) Applicant: Dedric M. Derr, Oklahoma City, OK (US)

(72) Inventor: Dedric M. Derr, Oklahoma City, OK (US)

(21) Appl. No.: 18/752,441

(22) Filed: Jun. 24, 2024

Related U.S. Application Data
(60) Provisional application No. 63/509,830, filed on Jun. 23, 2023.

(51) Int. Cl. A01K 83/06

(52) U.S. Cl. CPC A01K 83/061

(57) ABSTRACT

A system and a method for making a fishing bait by utilizing a bait mesh wrap is disclosed. The system and method enable the user to utilize a wider range of bait for fishing without worrying about wasting the bait by better securing the bait to any fishing hook. The system includes a bait mesh wrap and a bait material. The bait mesh wrap is designed to envelop the bait material to form a single bait structure that can be used as a traditional fishing bait. The bait mesh wrap further facilitates the attachment of the bait material to a fishing hook. The bait material corresponds to any type of bait the user desires to use to lure the target fish or other aquatic life.

### FIELD OF THE INVENTION

The present invention relates generally to a fishing equipment. More specifically, the present invention discloses a bait mesh wrap that facilitates the use of any type of bait for fishing.

### BACKGROUND OF THE INVENTION

Fishing bait includes a wide variety of food, living, and artificial bait that can be utilized by fishermen to lure different types of aquatic life. In general, fishing bait is attached onto a hook or similar fishing device to attract the desired fish towards the hook. The fish would try to eat the bait and get ensnared on the hook. Over the years, this process has been refined to more efficiently attract and trap various fishes and other aquatic life. However, there is often the difficulty of keeping the bait securely attached to the hook once deployed in the water. Solid bait can more easily be attached and stay attached onto the hook; specially artificial bait that is designed to be attached onto hooks. On the other hand, soft bait can be difficult to attach to the hook in a proper and secure manner. In addition, soft bait can often fall off the hook once deployed into the water, which results in a waste of bait. There is a need for a better bait system that allows different bait to be properly and securely attached to the hook without specialized tools and/or accessories.

Therefore, an objective of the present invention is to provide a system and a method for making a fishing bait by utilizing a bait mesh wrap that facilitates the attachment of any type of bait to a hook. The present invention is designed to prevent the bait from falling off the hook regardless of the consistency of shape of the bait, thus preventing wasting bait. Another objective of the present invention is to provide a system and a method that allows different types of objects, animals, or foods to be used as bait. The present invention allows unconventional bait (e.g., bread, cheese, hamburger, liver, etc.) to be securely attached to the hook without risk of the bait falling off the hook. Additional features and benefits of the present invention are further discussed in the sections below.

### SUMMARY OF THE INVENTION

The present invention discloses a system and a method for making a fishing bait by utilizing a bait mesh wrap. The bait mesh wrap of the present invention allows the use of a wider range of objects as bait including, but not limited to, food products, live bait, artificial bait, etc. The present invention allows the user to securely attach any type of bait to a hook without risk of the bait falling off the hook while fishing in order to prevent wasting bait. To do so, the bait mesh wrap is designed as a malleable mesh structure that can accommodate the desired bait regardless of the shape or size of the desired bait. The bait mesh wrap also enables the attachment of the desired bait to any type of fishing hook without the use of external accessories or tools. The bait mesh wrap can be made from different materials including, but not limited to, metal or plastic mesh materials with different shapes and sizes to accommodate a wide range of potential baits. By wrapping the desired bait with the bait mesh wrap, a single bait structure is formed that can be securely attached onto the fishing hook so that the single bait structure can be securely deployed into a body of water in order to attract and ensnare the target fish or other aquatic life.

### BRIEF DESCRIPTION OF THE DRAWINGS

FIG. 1 is a top-rear perspective view of the present invention, wherein three baits are shown attached to receiving hooks using a corresponding bait mesh wrap.

FIG. 2 is a top-front perspective view of the present invention, wherein the bait is shown attached to the receiving hook using a bait mesh wrap, and wherein the bait is shown positioned on the hook bend of the receiving hook.

FIG. 3 is a top-rear perspective view thereof.

FIG. 4 is a top-front perspective view thereof, wherein the bait covered with the bait mesh wrap is shown positioned on the hook shank of the receiving hook.

FIG. 5 is a bottom-front perspective view thereof.

FIG. 6 is a top-front perspective view of the present invention, wherein bait mesh wrap of the present invention is shown in a flat configuration.

FIG. 7 is a top view thereof, wherein several bait mesh wraps are shown.

FIG. 8 is a top-front perspective view of the present invention, wherein bait mesh wrap of the present invention is shown covering bait material.

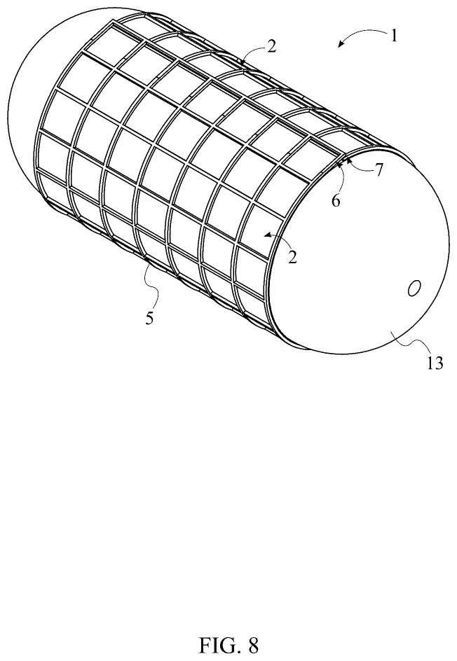

FIG. 9 is a side view thereof.

FIG. 10 is a flowchart showing the overall process of the method of the present invention.

FIG. 11 is a flowchart showing the subprocess of trimming down the bait mesh wrap of the present invention.

FIG. 12 is a flowchart showing the subprocess of attaching the single bait structure of the present invention to the receiving hook.

FIG. 13 is a flowchart showing the subprocess of engaging the single bait structure of the present invention with the hook barb.

FIG. 14 is a flowchart showing the subprocess positioning the single bait structure of the present invention on the hook shank.

### DETAIL DESCRIPTIONS OF THE INVENTION

All illustrations of the drawings are for the purpose of describing selected versions of the present invention and are not intended to limit the scope of the present invention.

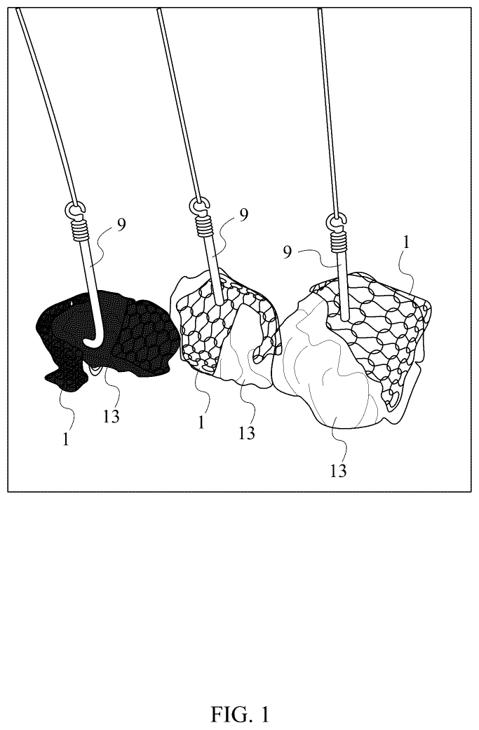

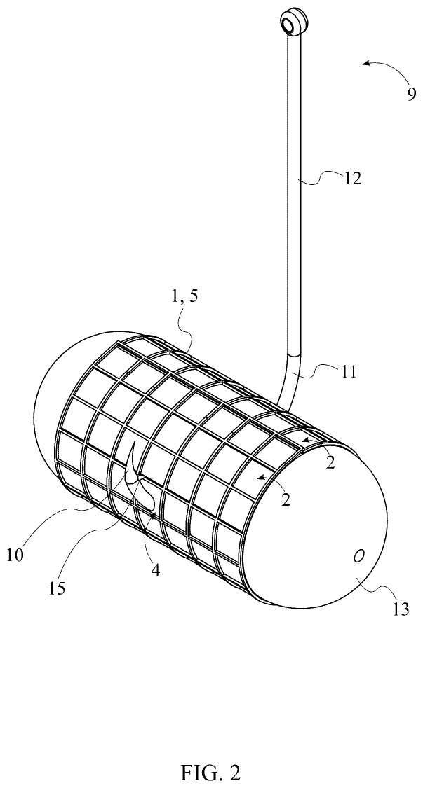

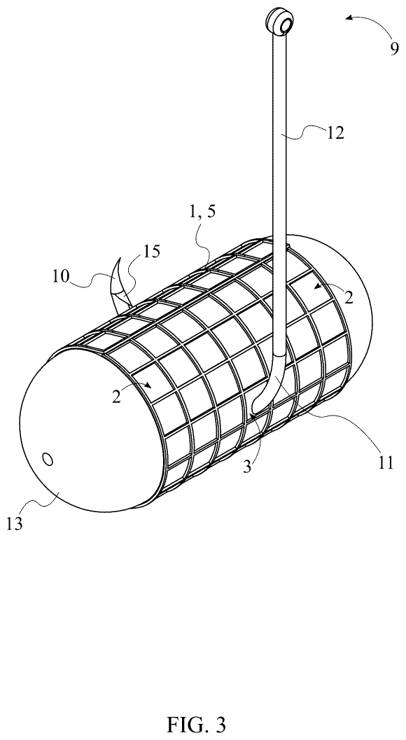

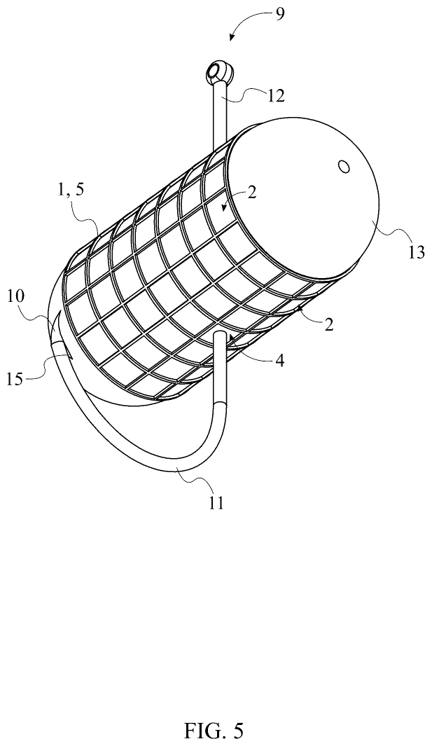

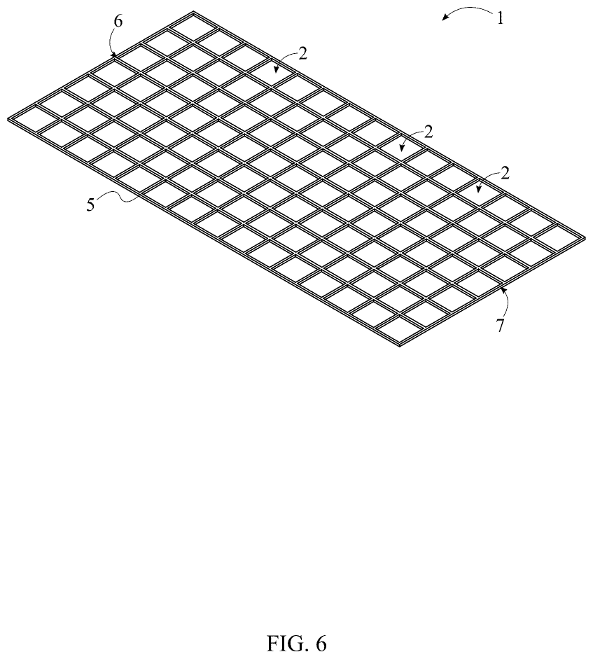

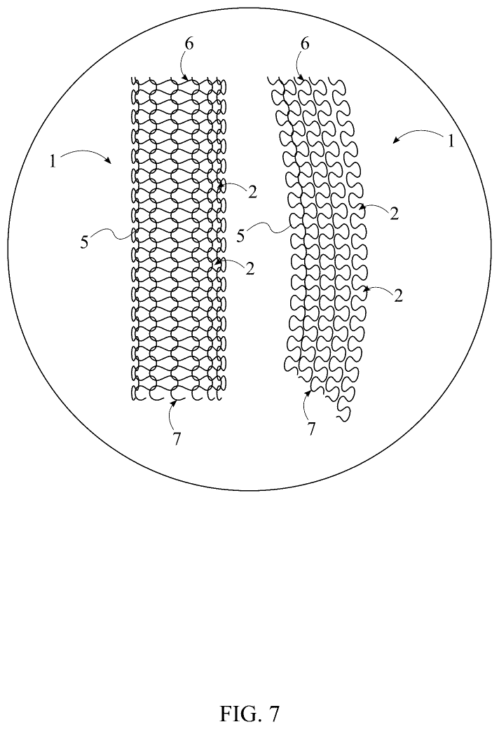

The present invention discloses a system and a method for making a fishing bait by utilizing a bait mesh wrap. The present invention enables the user to utilize a wider range of bait for fishing without worrying about wasting the bait by preventing the bait from falling off any fishing hook while fishing. As can be seen in FIG. 1 through 7, the present invention comprises a bait mesh wrap 1 and a bait material 13. The bait mesh wrap 1 is designed to envelop the bait material 13 to form a single bait structure 14 that can be used as a traditional fishing bait. The bait material 13 corresponds to any type of bait the user desires to use to lure the target fish or other aquatic life.

The general configuration of the aforementioned components enables the user to utilize any appropriate bait without the risk of the bait falling off while fishing. As can be seen in FIG. 1 through 7, the bait mesh wrap 1 is a malleable structure that can be configured to contain the bait material 13. The bait mesh wrap 1 comprises a mesh body 5 corresponding to the main structure of the bait mesh wrap 1 and a plurality of mesh holes 2 that allow the scent emanated from the bait material 13 to lure the target fish. In the preferred embodiment, the present invention can be arranged as follows: the plurality of mesh holes 2 is distributed throughout the mesh body 5 to enable the widespread diffusion of the scent of the bait material 13 to the surroundings. In addition, the bait material 13 is situated upon the mesh body 5 so that the user can wrap the mesh body 5 around the bait material 13. Further, the bait material 13 is enveloped by the mesh body 5 so that the bait material 13 remains within the mesh body 5. In the preferred embodiment, the mesh body 5 is made from a malleable mesh material including, but not limited to, wire mesh material, plastic mesh material, etc. Further, the bait material 13 can include, but is not limited to, any type of bait that can be used to lure a target fish such as live bait, artificial bait, food products, etc.

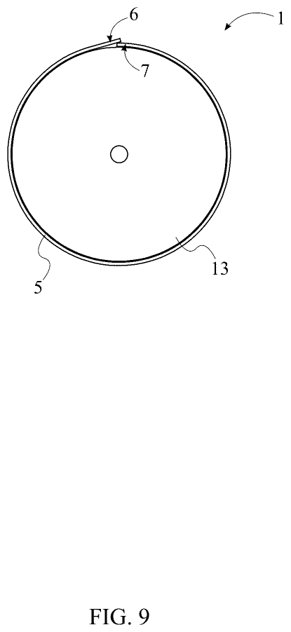

In some embodiments, the bait mesh wrap 1 can be provided as a piece of mesh material with a specific shape and size. As can be seen in FIG. 9 through 12, the bait mesh wrap 1 may comprise a first lateral end 6, and a second lateral end 7. In this embodiment, the mesh body 5 is provided as a rectangular mesh body 5 with the first lateral end 6 and the second lateral end 7 corresponding to the opposite terminal ends of the mesh body 5. To envelop the bait material 13 with the bait mesh wrap 1, the bait material 13 is centered on the mesh body 5 so that the mesh body 5 can fully cover the bait material 13. The first lateral end 6 is wrapped around the bait material 13 to cover half of the bait material 13 with half of the mesh body 5. Likewise, the second lateral end 7 is also wrapped around the bait material 13, opposite to the first lateral end 6, to cover the other half of the bait material 13. Further, the second lateral end 7 overlaps the first lateral end 6 to secure the mesh body 5 around the bait material 13 to form the single bait structure 14. In other embodiments, the bait mesh wrap 1 can be provided as a long sheet of mesh material that the user can cut into smaller sections. In addition, removable fasteners or other fastening mechanisms can be implemented to further secure the mesh body 5 to the bait material 13.

As can be seen in FIG. 1 through 6, the formed single bait structure 14 can be easily attached to a fishing hook so that the user can capture the target fish or other aquatic life. So, the present invention may further comprise a receiving hook 9 that is designed to retain the single bait structure 14 so that the target fish is lured by the bait material 13 retained within the bait mesh wrap 1. The receiving hook 9 is also designed to ensnare the target fish once the target fish bites the single bait structure 14. To attach the single bait structure 14 to the receiving hook 9, the receiving hook 9 traverses into an arbitrary mesh hole 3 of the plurality of mesh holes 2, through the bait material 13, and out of an opposite corresponding mesh hole 4 of the plurality of mesh holes 2. As a result, the bait mesh wrap 1 and the bait material 13 are suspended on the receiving hook 9 so that the bait material 13 lures the target fish. In other embodiments, the bait mesh wrap 1 can be provided pre-attached to the receiving hook 9 to further facilitate the attachment of the bait material 13 to the receiving hook 9.

As previously discussed, the single bait structure 14 is attached to the receiving hook 9 by piercing the receiving hook 9 through the bait mesh wrap 1 and the bait material 13. As can be seen in FIG. 1 through 3, to facilitate the single bait structure 14 by the receiving hook 9, the receiving hook 9 may comprise a sharp end 10, a hook barb 15, and a hook bend 11. The sharp end 10 corresponds to the point of the receiving hook 9 that facilitates the piercing of the bait material 13. The hook barb 15 ensures that the target fish is ensnared once the target fish bites onto the single bait structure 14. The hook barb 15 also ensures that the single bait structure 14 remains attached to the receiving hook 9. In addition, the hook bend 11 corresponds to the curved section of the hook that facilitates the ensnaring of the target fish. In general, the hook bend 11 is positioned adjacent to the sharp end 10 along the receiving hook 9. In addition, the hook barb 15 is positioned in between the sharp end 10 and the hook bend 11. Further, when attaching the single bait structure 14 to the receiving hook 9, the sharp end 10 traverses into the arbitrary mesh hole 3, through the bait material 13, and out of the opposite corresponding mesh hole 4. This way, the bait mesh wrap 1 and the bait material 13 are positioned along the hook bend 11 so that when the target fish bites onto the single bait structure 14, the sharp end 10 pierces the target fish's mouth to ensure that the target fish is ensnared. In addition, the hook barb 15 engages with the opposite corresponding mesh hole 4 to prevent the detachment of the single bait structure 14 from the receiving hook 9. In other embodiment, the receiving hook 9 may include custom designs to accommodate the bait in different manners.

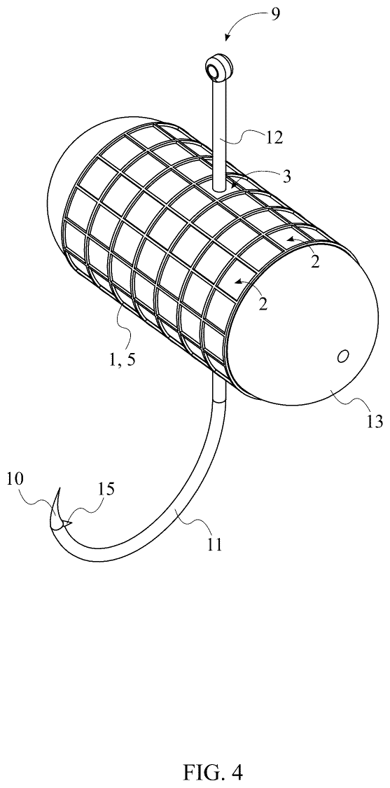

In some embodiments, the bait material 13 may be positioned at different locations along the receiving hook 9 to properly ensnare the target fish. As can be seen in FIG. 4 through 7, the receiving hook 9 may further comprise a hook shank 12 corresponding to the straight section of the receiving hook 9. The hook shank 12 is positioned adjacent to the hook bend 11, opposite to the sharp end 10, due to the overall shape of the receiving hook 9. To position the single bait structure 14 on the hook shank 12, the sharp end 10 and the hook bend 11 traverse into the arbitrary mesh hole 3, through the bait material 13, and out of the opposite corresponding mesh hole 4. This way, the bait mesh wrap 1 and the bait material 13 are positioned along the hook shank 12 so that when the target fish bites onto the single bait structure 14, the sharp end 10 pierces a deeper area inside the target fish's mouth. In other embodiments, different hook designs can be implemented to ensnare different aquatic life.

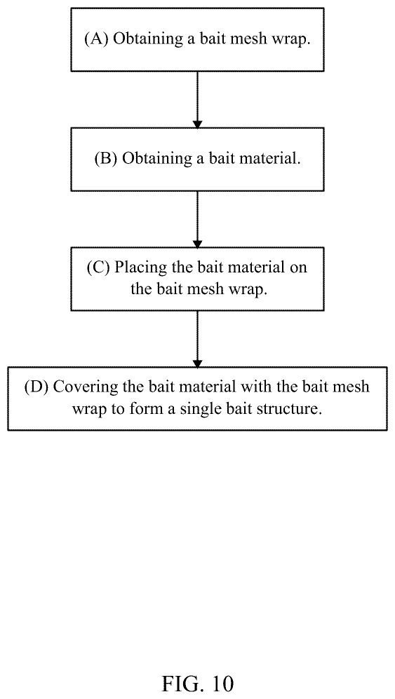

In the preferred embodiment, the method of making a fishing bait by utilizing a bait mesh wrap 1 can be performed as follows: the overall process of the method of the present invention starts by obtaining a bait mesh wrap 1 (Step A) and a desired bait material 13 (Step B), as can be seen in FIG. 10. The bait mesh wrap 1 is preferably large enough to retain most or all of the bait material 13 depending on the structure of the bait material 13. Then, the bait material 13 is placed on the bait mesh wrap 1 (Step C) so that the user can cover the bait material 13 with the bait mesh wrap 1. Finally, the bait material 13 is covered with the bait mesh wrap 1 to form a single bait structure 14 (Step D) that can be attached to the desired receiving hook 9.

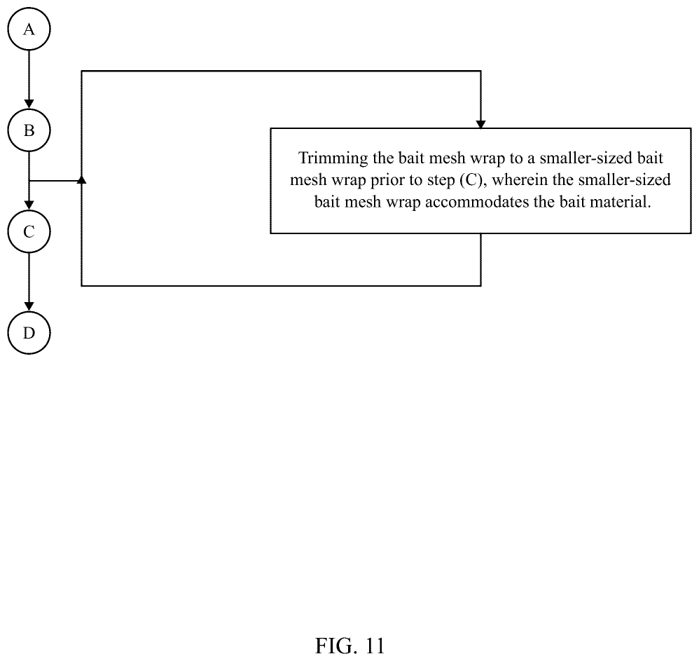

In embodiments where the bait mesh wrap 1 is provided as long sheets of mesh materials, the user may have to cut a smaller piece of mesh material that is large enough to partially or fully cover the bait material 13. As can be seen in FIG. 11, the subprocess of trimming down the bait mesh wrap 1 includes the step of trimming the bait mesh wrap 1 to a smaller-sized bait mesh wrap 1 prior to Step C. The smaller-sized bait mesh wrap 1 accommodates the bait material 13 and can include any shape suitable for the bait material 13.

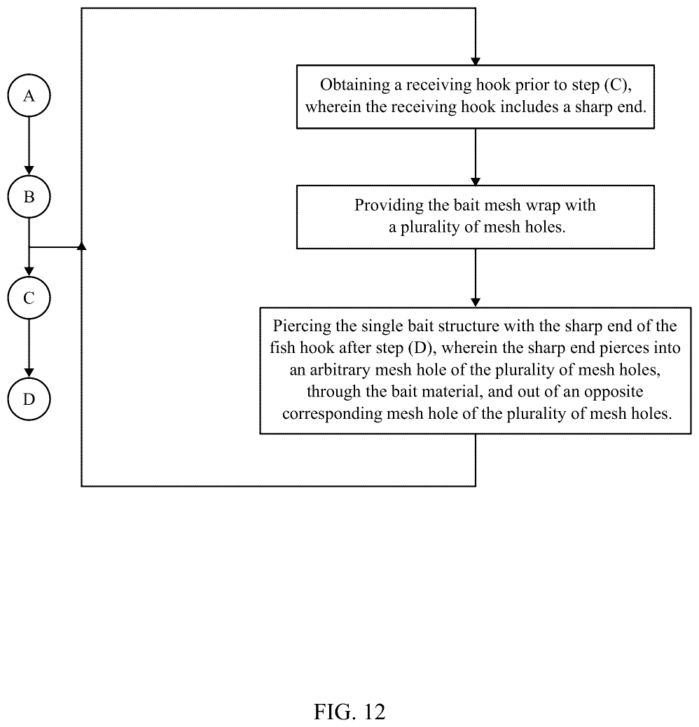

Once the user has formed the single bait structure 14 by covering the bait material 13 with the bait mesh wrap 1, the user can then proceed to attach the single bait structure 14 to the receiving hook 9. As can be seen in FIG. 12, the subprocess of attaching the single bait structure 14 to the receiving hook 9 includes the step of piercing the single bait structure 14 with the sharp end 10 of the fish hook after Step D. The sharp end 10 pierces into an arbitrary mesh hole 3 of the plurality of mesh holes 2, through the bait material 13, and out of an opposite corresponding mesh hole 4 of the plurality of mesh holes 2. In other embodiments, the user may pierce the receiving hook 9 just through the bait material 13, if necessary, without piercing through the bait mesh wrap 1.

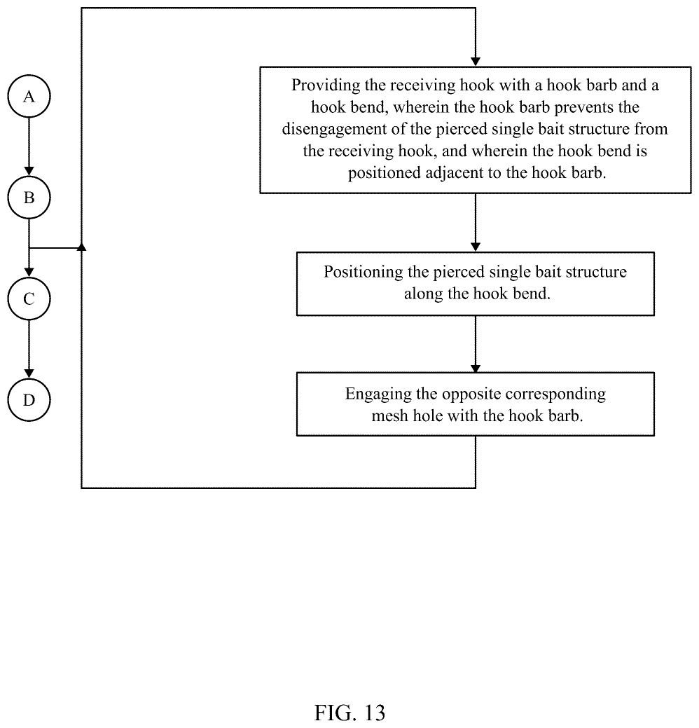

In embodiments where the receiving hook 9 includes a hook barb 15, the user may engage the single bait structure 14 with the hook barb 15 to keep the single bait structure 14 attached to the receiving hook 9. As can be seen in FIG. 13, the subprocess of engaging the single bait structure 14 with the hook barb 15 includes the steps of positioning the pierced single bait structure 14 along the hook bend 11 to attach the single bait structure 14 to the receiving hook 9. Then, the opposite corresponding mesh hole 4 is engaged with the hook barb 15 to secure the single bait structure 14 to the receiving hook 9. In other embodiments, different fasteners can be utilized to secure the single bait structure 14 to the receiving hook 9.

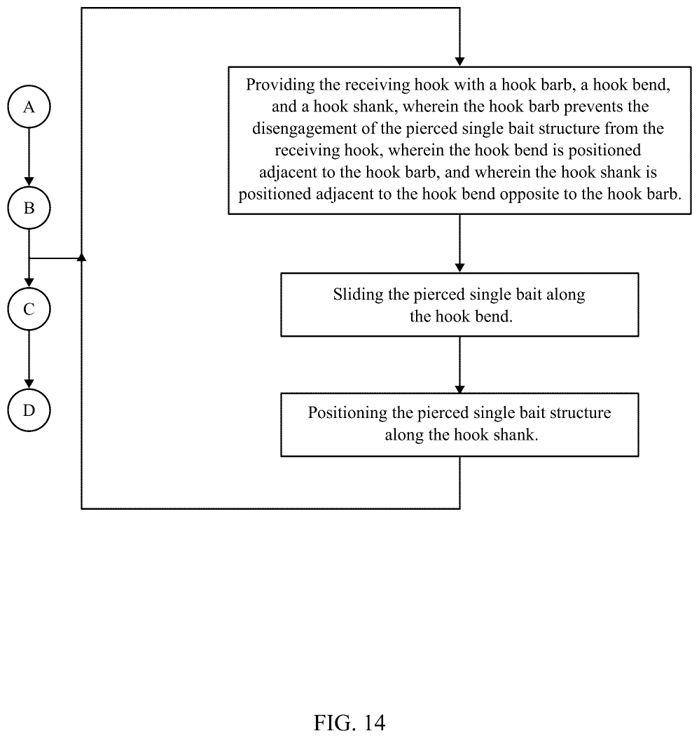

In embodiments where the single bait structure 14 needs to be positioned closer to the hook shank 12, the user needs to slide the pierced single bait structure 14 further along the receiving hook 9. As can be seen in FIG. 14, the subprocess positioning the single bait structure 14 on the hook shank 12 includes the steps of sliding the pierced single bait along the hook bend 11 so that the pierced single bait structure 14 reaches the hook shank 12. Then, the pierced single bait structure 14 is positioned along the hook shank 12. In other embodiments, the pierced single bait structure 14 can be positioned at different locations along the receiving hook 9 depending on the hook design.

Although the invention has been explained in relation to its preferred embodiment, it is to be understood that many other possible modifications and variations can be made without departing from the spirit and scope of the invention.

What is claimed is:

1. A method for making a fishing bait by utilizing a bait mesh wrap comprising the steps of:
(A) obtaining a bait mesh wrap;
(B) obtaining a bait material;
(C) placing the bait material on the bait mesh wrap; and
(D) covering the bait material with the bait mesh wrap to form a single bait structure.

2. The method as claimed in claim 1 further comprising the step of:
trimming the bait mesh wrap to a smaller-sized bait mesh wrap prior to step (C), wherein the smaller-sized bait mesh wrap accommodates the bait material.

3. The method as claimed in claim 1 further comprising the steps of:
obtaining a receiving hook prior to step (C), wherein the receiving hook includes a sharp end;
providing the bait mesh wrap with a plurality of mesh holes; and
piercing the single bait structure with the sharp end of the fish hook after step (D), wherein the sharp end pierces into an arbitrary mesh hole of the plurality of mesh holes, through the bait material, and out of an opposite corresponding mesh hole of the plurality of mesh holes.

4. The method as claimed in claim 3 further comprising the steps of:
providing the receiving hook with a hook barb and a hook bend, wherein the hook barb prevents the disengagement of the pierced single bait structure from the receiving hook, and wherein the hook bend is positioned adjacent to the hook barb;
positioning the pierced single bait structure along the hook bend; and
engaging the opposite corresponding mesh hole with the hook barb.

5. The method as claimed in claim 3 further comprising the steps of:
providing the receiving hook with a hook barb, a hook bend, and a hook shank, wherein the hook barb prevents the disengagement of the pierced single bait structure from the receiving hook, wherein the hook bend is positioned adjacent to the hook barb, and wherein the hook shank is positioned adjacent to the hook bend opposite to the hook barb;
sliding the pierced single bait along the hook bend; and
positioning the pierced single bait structure along the hook shank.

6. A system for making a fishing bait by utilizing a bait mesh wrap comprising:
a bait mesh wrap;
a bait material;
the bait mesh wrap comprising a mesh body and a plurality of mesh holes;
the plurality of mesh holes being distributed throughout the mesh body;
the bait material being situated upon the mesh body; and
the bait material being enveloped by the mesh body.

7. The system as claimed in claim 6 further comprising:
the bait mesh wrap further comprising a first lateral end and a second lateral end;
the bait material being centered on the mesh body;
the mesh body being wrapped around the bait material;
the first lateral end being wrapped around the bait material;
the second lateral end being wrapped around the bait material, opposite to the first lateral end; and
the second lateral end overlapping the first lateral end.

8. The system as claimed in claim 6, wherein the mesh body is made from a malleable mesh material.

9. The system as claimed in claim 6 further comprising:
a receiving hook;
the receiving hook traversing into an arbitrary mesh hole of the plurality of mesh holes, through the bait material, and out of an opposite corresponding mesh hole of the plurality of mesh holes; and
the bait mesh wrap and the bait material being suspended on the receiving hook.

10. The system as claimed in claim 9 further comprising:
the receiving hook comprising a sharp end, a hook barb, and a hook bend;
the hook bend being positioned adjacent to the sharp end;
the hook barb being positioned in between the sharp end and the hook bend;
the sharp end traversing into the arbitrary mesh hole, through the bait material, and out of the opposite corresponding mesh hole;
the bait mesh wrap and the bait material being positioned along the hook bend; and
the hook barb being engaged with the opposite corresponding mesh hole.

11. The system as claimed in claim 9 further comprising:
the receiving hook comprising a sharp end, a hook bend, and a hook shank;
the hook bend being positioned adjacent to the sharp end;
the hook shank being positioned adjacent to the hook bend, opposite to the sharp end;
the sharp end and the hook bend traversing into the arbitrary mesh hole, through the bait material, and out of the opposite corresponding mesh hole; and
the bait mesh wrap and the bait material being positioned along the hook shank.
